(19) United States
(12) Patent Application Publication
(10) Pub. No.: US 2018/0188976 A1
(43) Pub. Date: Jul. 5, 2018

(54) INCREASING READ PENDING QUEUE CAPACITY TO INCREASE MEMORY BANDWIDTH

(71) Applicant: Intel Corporation, Santa Clara, CA (US)

(72) Inventors: Gunjae Koo, Claremont, CA (US); Vivek Kozhikkottu, Hillsboro, OR (US); Shankar Ganesh Ramasubramanian, Hillsboro, OR (US); Christopher B. Wilkerson, Portland, OR (US)

(73) Assignee: Intel Corporation, Santa Clara, CA (US)

(21) Appl. No.: 15/395,615

(22) Filed: Dec. 30, 2016

(51) Int. Cl. G06F 3/06; G06F 12/06

(52) U.S. Cl. CPC G06F 3/0613; G06F 12/06; G06F 3/0673; G06F 3/0659; G06F 3/0658

(57) ABSTRACT

Devices, systems, and methods for increasing the size of a read pending queue (RPQ) in a memory controller are described. An example of increasing the RPQ size can include receiving, at a memory controller, a read request for data in a memory having a physical address identification (ID) including row and column ID, performing a lookup of the RPQ for an entry having a pending read transaction with a physical address ID having the same row ID as the incoming read request, and, if the RPQ lookup returns a hit, appending the incoming read request's column ID to the physical address ID of the pending read transaction to form an appended read transaction. The appending read transaction can then be queued and processed sequentially, while occupying a single RPQ entry.

### BACKGROUND

Computer systems operate by executing instruction sequences that form a computer program. These instructions sequences are stored in a memory subsystem along with any data operated on by the instructions, both of which are retrieved as necessary by a processor, such as a central processing unit (CPU). The speed of CPUs have increased at a much faster rate compared to the memory subsystems upon which they rely for data and instruction code, and as such, memory subsystems have become a significant performance bottleneck. While one solution to this bottleneck would be to primarily use only very fast memory, such as static random-access memory (SRAM), in a computer system, the cost of such memory would be prohibitive. In order to balance cost with system performance, memory subsystem architecture is typically organized in a hierarchical structure, with faster expensive memory operating near the processor at the top, slower less expensive memory operating as storage memory at the bottom, and memory having an intermediate speed and cost, such as dynamic random-access memory (DRAM), operating in the middle of the memory hierarchy.

Further techniques can be implemented in order to further improve the efficiency of this memory hierarchy. For example, cache buffering of data between memory levels can reduce the frequency that lower speed memory is accessed. In another example, parallel access channels can be used, both within and in between memory levels, to perform data operations in parallel.

### BRIEF DESCRIPTION OF THE DRAWINGS

FIG. 1 illustrates two instances of a read pending queue (RPQ) in accordance with an example embodiment;

FIG. 2 illustrates an appended read transaction in accordance with an example embodiment;

FIG. 3 illustrates a block diagram of selected components of a memory system in accordance with an example embodiment;

FIG. 4 is a diagram showing the entering of incoming read requests into an RPQ in accordance with an example embodiment;

FIG. 5 illustrates a bank of a memory in accordance with an example embodiment;

FIG. 6 is a diagram showing the processing of a read transaction in accordance with an example embodiment;

FIG. 7 is an illustration of an appended read transaction in an RPQ at different points in time in accordance with an example embodiment; and

FIG. 8 is a block diagram of a computing system in accordance with an example embodiment.

### DESCRIPTION OF EMBODIMENTS

Although the following detailed description contains many specifics for the purpose of illustration, a person of ordinary skill in the art will appreciate that many variations and alterations to the following details can be made and are considered included herein. Accordingly, the following embodiments are set forth without any loss of generality to, and without imposing limitations upon, any claims set forth. It is also to be understood that the terminology used herein is for describing particular embodiments only, and is not intended to be limiting. Unless defined otherwise, all technical and scientific terms used herein have the same meaning as commonly understood by one of ordinary skill in the art to which this disclosure belongs. Also, the same reference numerals in appearing in different drawings represent the same element. Numbers provided in flow charts and processes are provided for clarity in illustrating steps and operations and do not necessarily indicate a particular order or sequence.

Furthermore, the described features, structures, or characteristics can be combined in any suitable manner in one or more embodiments. In the following description, numerous specific details are provided, such as examples of layouts, distances, network examples, etc., to provide a thorough understanding of various embodiments. One skilled in the relevant art will recognize, however, that such detailed embodiments do not limit the overall concepts articulated herein, but are merely representative thereof. One skilled in the relevant art will also recognize that the technology can be practiced without one or more of the specific details, or with other methods, components, layouts, etc. In other instances, well-known structures, materials, or operations may not be shown or described in detail to avoid obscuring aspects of the disclosure.

In this application, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open-ended term in this written description, like “comprising” or “including,” it is understood that direct support should be afforded also to “consisting essentially of” language as well as “consisting of” language as if stated explicitly and vice versa.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. However, it is to be understood that even when the term “about” is used in the present specification in connection with a specific numerical value, that support for the exact numerical value recited apart from the “about” terminology is also provided.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 1.5, 2, 2.3, 3, 3.8, 4, 4.6, 5, and 5.1 individually.

This same principle applies to ranges reciting only one numerical value as a minimum or a maximum. Furthermore, such an interpretation should apply regardless of the breadth of the range or the characteristics being described.

Reference throughout this specification to “an example” means that a particular feature, structure, or characteristic described in connection with the example is included in at least one embodiment. Thus, appearances of phrases including “an example” or “an embodiment” in various places throughout this specification are not necessarily all referring to the same example or embodiment.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein.

As used herein, comparative terms such as “increased,” “decreased,” “better,” “worse,” “higher,” “lower,” “enhanced,” and the like refer to a property of a device, component, or activity that is measurably different from other devices, components, or activities in a surrounding or adjacent area, in a single device or in multiple comparable devices, in a group or class, in multiple groups or classes, or as compared to the known state of the art. For example, a data region that has an “increased” risk of corruption can refer to a region of a memory device which is more likely to have write errors to it than other regions in the same memory device. A number of factors can cause such increased risk, including location, fabrication process, number of program pulses applied to the region, etc.

An initial overview of embodiments is provided below and specific embodiments are then described in further detail. This initial summary is intended to aid readers in understanding the disclosure more quickly, but is not intended to identify key or essential technological features, nor is it intended to limit the scope of the claimed subject matter.

The presently disclosed technology relates to increasing the bandwidth of a page-based memory system through increasing the efficiency of the read request buffering of the system. In one example, such an efficiency increase can be accomplished by increasing the effective size of one or more Read Pending Queues (RPQ) that buffer read requests between a host and a memory. Various traditional techniques have been utilized in attempts to improve memory bandwidth that involve the RPQ. For example, one technique is to increase the number of entries by increasing the size of the RPQ in order to improve RPQ utilization by the memory controller through memory-level parallelism. However, there is a physical limit to how much the physical size of the RPQ can be increased (for example, the number of entries that can be added to the RPQ) before timing and other resource constraints become limiting.

Various devices, subsystems, systems, methods, and the like, are provided that can increase the effective size and efficiency of a RPQ of a controller associated with memory. Exemplary memory can include any combination of random access memory (RAM), such as static random access memory (SRAM), dynamic random access memory (DRAM), synchronous dynamic random access memory (SDRAM), and the like. In some examples, DRAM complies with a standard promulgated by JEDEC, such as JESD79F for Double Data Rate (DDR) SDRAM, JESD79-2F for DDR2 SDRAM, JESD79-3F for DDR3 SDRAM, or JESD79-4A for DDR4 SDRAM (these standards are available at www.jedec.org). Such standards (and similar standards) may be referred to as DDR-based standards, and communication interfaces of the storage devices that implement such standards may be referred to as DDR-based interfaces. In some nonlimiting examples, the memory can be DRAM. It is noted that, while much of the present disclosure is directed to DRAM, the present scope includes any type of memory, or memory subsystem, that utilizes RPQ buffering. For example, the present scope extends to any page-based memory system.

DRAM memory is organized in a hierarchical fashion, with a memory-level parallelism organization that provides increased bandwidth at certain levels of the hierarchy. For example, one high-level division of memory is a channel, which is the collection of all DRAM that share a common physical link to a host (e.g. a processor), and the channel is broken down into multiple dual in-line memory modules (DIMM), with each DIMM having a plurality of DRAM chips mounted thereon. Depending on the type of DRAM, the DIMM can have DRAM chips on one side, or on both sides. The next level of hierarchy down from the DIMM is the rank, which includes all of the DRAM chips on one side of the DIMM. Thus, DIMMs having DRAM chips on both sides have two ranks, one on each side. Further down the hierarchy, each DRAM chip is divided into a number of banks. The DRAM cells (bit-level) themselves are usually arranged in a two-dimensional array of rows and columns in each bank. As such, data that is stored in DRAM can be addressed using the channel, DIMM, rank, bank, row, and column identifiers (IDs) to direct data communications through the hierarchy. The channel ID can be optional, and may not be necessary in cases where, for example, a memory system includes a single memory controller coupled to only a single DRAM channel. Additionally, in some examples, the DIMM ID can be optional. For example, assuming all ranks in a channel have a unique rank ID, a DIMM ID would not be needed to uniquely identify each rank.

Each bank can process data requests independently of one another, which has the effects of increasing bandwidth and reducing response latencies. These effects are further multiplied through the use of data request buffers that queue incoming read and write requests from a host, such as a processor, processor core, or processor cache, which are then processed as data transactions. Through the use of such buffers, the host does not need to wait for a bank to finish processing a data transaction before sending another data request to the same bank. In the case of data requests for read transactions, a memory controller can include a RPQ for accepting and buffering incoming read requests from the host, where they can be arbitrated, temporarily stored, and sent to the appropriate banks. As used herein, the term “data request” refers to a communication from a host requesting that a data transaction be performed, such as a read or a write, for example. Thus, a “read request” is a data request for a read operation. Furthermore, the term “data transaction” refers to the implementation and performance of the data request in a memory controller and a memory, as well as the set of address IDs and DRAM commands used in such implementation. Thus, a “read transaction” is a data transaction of a read request. In one specific example, a data transaction can also refer to the set of address IDs in an entry of the RPQ.

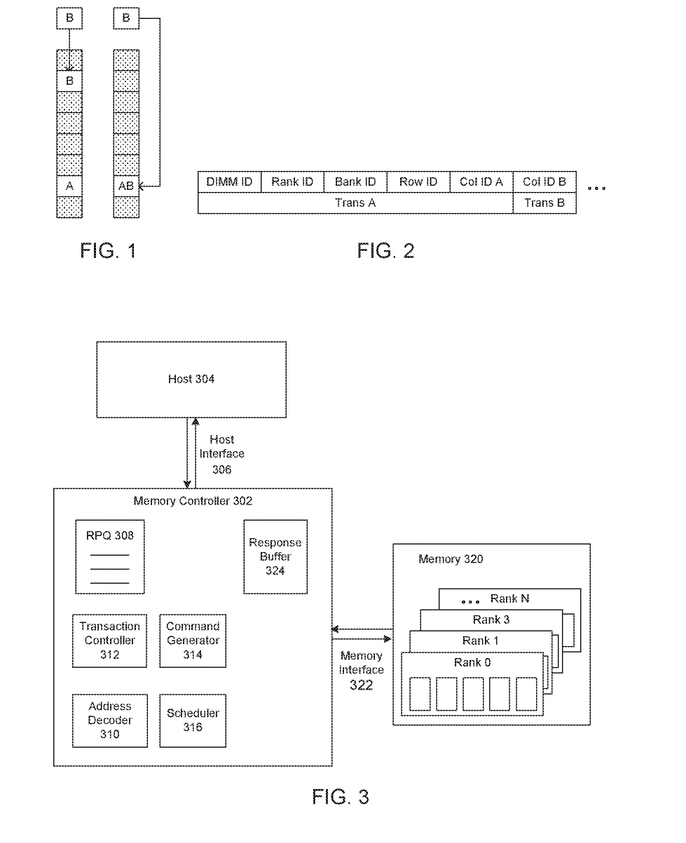

The presently disclosed technology increases the capacity of the RPQ without increasing the number of individual entries. For example, FIG. 1 shows examples of two instances of an RPQ. The RPQ instance on the left includes a pending read transaction (A) and an incoming read request (B) just entering the queue. In the traditional case, the incoming read request B would be entered into the RPQ as a new entry, as is shown in the left RPQ instance, where the pending read transaction A and the newly-entered read transaction B occupy two separate entries of the queue. The RPQ on the right, however, combines the incoming read request B with the pending read transaction A in the same entry of the queue. In one example of the presently disclosed technology, when the incoming read request B arrives at the memory controller, a lookup is performed on the RPQ for a pending read transaction to the same row in DRAM as the incoming read request B. If the lookup returns a hit, the data associated with the pending read transaction and the data associated with the incoming read request are located on the same physical row in the DRAM. In response, the memory controller generates a read transaction B from the incoming read request B and appends the read transaction B to the pending read transaction A in the same entry. As such, the effective size of the RPQ is effectively increased by decreasing the number of individual entries needed to queue the data transactions.

In appending a read transaction for an incoming read request to a pending read request, the memory controller can take advantage of redundancies in the physical addresses of the data associated with the requests. As described above, the location of the associated data for each read request is addressed according to at least the rank, bank, row, and column ID, which can be referred to herein collectively as a physical ID (which can also include channel and DIMM IDs). Because the associated data for each of the pending and incoming read requests are located on the same row in DRAM, the rank, bank, and row IDs are the same for both read requests, and are thus redundant, assuming, of course, that the channel and DIMM IDs are also the same. With the exception of the column ID, the physical IDs for these read requests are the same, and the memory controller can generate an incoming read transaction from the incoming read request using just the column ID as the address, which is appended to the pending read transaction entry in the RPQ. In one example, as is shown in FIG. 2, the physical ID entry in the RPQ associated with the pending read transaction A (Trans A) includes the DIMM, rank, bank, row, and column ID, with only the column ID of the incoming read transaction B (Trans B) appended thereto. Furthermore, while the entry remains in the RPQ, the column IDs of subsequent read transactions to the same row in DRAM can be appended to the entry. If the entry in the RPQ is filled, the size of the buffer can be increased to accommodate additional entries.

As a high-level description of memory data retrieval and storage in general, a host, such as one or more processors, processor cores, system-on-a-chip (SoC), various input/output (I/O) devices, and the like, sends data requests to a memory controller for processing. Because the host input can come from multiple sources, and arbitration interface can be used to sort the data requests according to priority, in some cases according to the various transaction and command scheduling policies. The associated arbitration logic can be part of a system controller at the host, part of the memory controller, or at some point along the host interface therebetween. Once through arbitration, data transactions can be generated from the data requests by mapping to the appropriate physical location for the requested data in memory, which is entered into the RPQ. In some examples, the physical location mapping can be a physical address ID comprising a channel, DIMM, rank, bank, row, and column ID, or any combination thereof, that uniquely identifies the location of the data in memory. It should be understood that the physical location IDs described are merely exemplary, and that memory architectures using other mapping schemes would have other physical address IDs, which are considered to be within the present scope. The term “physical address ID” is therefore used herein to refer to any sequence or portion of a sequence of location IDs used to map the physical address of requested data. For example, in one implementation the physical address ID can be the channel, DIMM, rank, bank, row, and column IDs that point to the associated data. In another example, the physical address ID can be the channel, rank, bank, row, and column IDs that point to the associated data. In another example, the physical address ID can be the DIMM, rank, bank, row, and column IDs that point to the associated data. In another example, the physical address ID can be the rank, bank, row, and column IDs that point to the associated data. As such, in one example, the physical address ID represents the set of location IDs that unambiguously maps to a physical location of memory, and that can be used by the memory controller to find and access data at that physical location. Additionally, reference to two segments of data “having the same row ID” refers to two segments of data that are physically located in the same row of memory, and, in the case of a DIMM-based architecture, would only differ in physical location according to which columns of the row each segment was stored in. It is noted that, while the present disclosure refers to memory organized according to a DIMM-based architecture, such is not considered to be limiting, and the present scope extents to any hierarchically-organized architecture of memory. Depending on the nature of the memory architecture, therefore, location IDs other than the examples illustrated above can be included in the physical address ID.

A data transaction for each data request, comprising the physical address ID of the requested data, is entered into either an RPQ or a write pending queue (WPQ), depending on the nature of the request. These queues can each be implemented as a generic queue pool, where the memory controller can select from pending data transactions process, or the queues can be implemented such that each rank has a designated queue, each bank has a designated queue, or the like. Data transactions can be scheduled prior to their input on the queues or while they are present on the queues. In one example, when a data transaction comes up for processing, appropriate DRAM commands are generated from, and associated with, the various IDs of the physical address ID, which are sent to the appropriate bank over a memory interface for processing.

FIG. 3 shows a nonlimiting example embodiment of a system block diagram of selected components of a memory system for processing data transactions. A memory controller 302 is communicatively coupled to a host 304 via a host interface 306. The host 304, can be one or more processors, one or more processor cores, various I/O devices, or any other host capable of sending a data request to the memory controller. In cases where the host 304 can include multiple hosts, an arbiter (not shown) can prioritize incoming data requests to allow data request buffering amongst the hosts. The memory controller 302 can include a RPQ 308 for queuing read transactions generated from read requests received from the host 304. In one example, the RPQ 308 can be implemented in hardware registers in the memory controller 102. An address decoder 310 translates the physical address of an incoming read request into a physical address ID, which is entered into the RPQ 308 as a read transaction. More specifically, when a read request enters the RPQ 308, the physical field address for the data to be read is decoded into the various channel, DIMM, rank, bank, row, and column IDs, which are used as pointers to access the correct data location in the physical DRAM. Additionally, timing constraints related to the physical structure and timing delay properties of DRAM are determined based on these IDs.

A transaction controller 312 performs a lookup of the RPQ entries in the RPQ 308 for an existing read transaction having the same channel, DIMM, rank, bank, and row ID as the incoming read request. If the lookup returns a miss, the transaction controller 312 enters the incoming read request into the RPQ 308 as a new read transaction entry. If the lookup returns a hit, the transaction controller 312 appends the column ID of the incoming read request (i.e., the incoming read transaction) to the physical address ID of the existing read transaction. Once the read transaction is selected for processing, command generator 314 generates DRAM commands from the channel, DIMM, rank, bank, row, and column IDs of the read transaction, which are sent to the memory 320 through memory interface 322. In some examples, read transactions are scheduled for processing by scheduler 316.

Because the subsequent read transaction is appended as a column ID to the initial read transaction in the RPQ entry, the number of read requests taking part in the arbitration for scheduling has not increased. The subsequent read transaction is invisible to the scheduler 316 as long as the initial read transaction has not completed. This is a substantial benefit of the presently disclosed technology, as arbitration for scheduling is a bottleneck to increasing RPQ size, which has been a problem for many of the prior attempts to increase RPQ size. As a consequence of the subsequent read transaction being hidden from the scheduler, the hardware complexity of the scheduler is not increased in the presently disclosed technology. Even in situations where multiple subsequent read transactions are appended to the initial read transaction, the memory controller will continue to process subsequent read transactions as long as the initial read transaction has not completed, which, in some examples, can occur when the RPQ entry is empty, if the memory controller is interrupted, or the like.

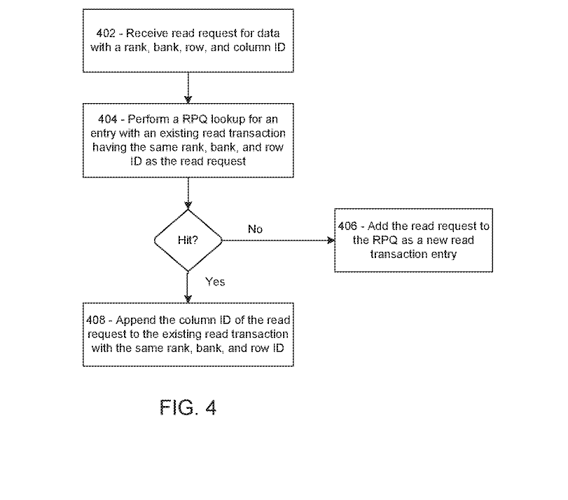

FIG. 4 shows a high-level example of a flow for entering incoming read requests into the RPQ. Initially, 402 a read request from a host 304 is received at a memory controller 302, where the read request has at least a rank, bank, row, and column ID, and in some cases an associated channel and/or DIMM ID. Once the read request has been received, 404 the memory controller 302 performs a lookup of the RPQ for an entry with an existing read transaction having the same rank, bank, and row ID as the read request. If the RPQ lookup returns a miss, 406 the read request is added to the RPQ as a new read transaction entry. Alternatively, if the RPQ lookup returns a hit, 408 the column ID of the read request is appended to the existing read transaction with the same rank, bank, and row ID. In some examples, the column ID of the read request is appended directly following the column ID of the existing read transaction.

The memory controller 302 is communicatively coupled to the memory 320 via memory interface 322. Read transactions are sent to the memory 320, and the requested data is sent back to the memory controller 302 through the memory interface 322. The memory controller 302 then responds to the read request by sending the requested read data to the host 304 via the host interface 306. In some cases, the read data entering the memory controller 302 can be queued in a response buffer 324 prior to being sent to the host 304. It is noted, that the described functions of a memory controller can be performed in various sequential orders, and can depend on a particular memory controller or memory system architecture. Additionally, the various functions can be implemented as discrete units of circuitry, logic, code, or the like, or one or more these functions can be commonly implemented or integrated in a unit of circuitry, logic, code, or the like. As such, the order in which functions have been described, as well as the discrete nature with which they have been described, is not limiting to the present scope, but is merely exemplary.

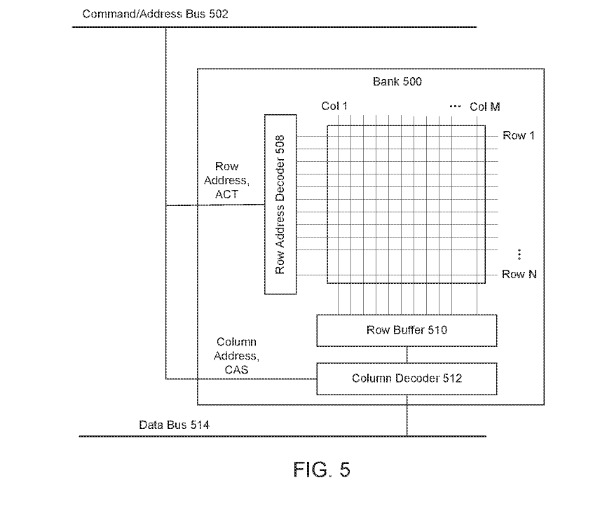

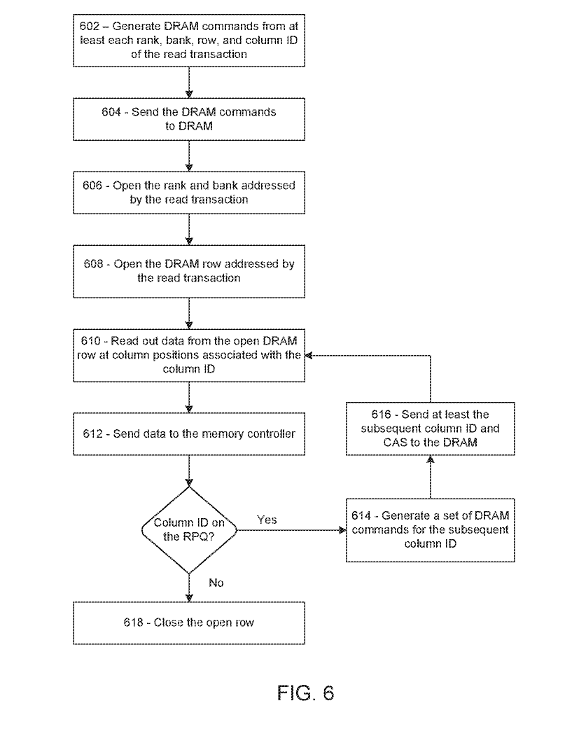

FIG. 5 shows an example embodiment of a single bank 500 of a DRAM chip, and FIG. 6 shows a high-level example of a flow for processing read transactions. DRAM cells in each bank are organized in a two-dimensional array, which is addressed by an array of bit lines (Col 1 to Col M) and word lines (Row 1 to Row N). When it comes up on the RPQ for processing by the memory controller, 602 DRAM commands are generated for at least each of the rank, bank, row, and column IDs of the read transaction. If the read transaction is an appended read transaction having multiple column IDs, the memory controller only generates DRAM commands first column ID associated with the first read transaction in the RPQ entry. The 604 DRAM commands are sent to the DRAM from the memory controller along a command address bus 502, causing 606 the rank (not shown) and bank 500 address by the read transaction to be opened. The row address (i.e., row ID) of the read transaction is sent via the command and address bus 502 to a row address decoder 506, along with an activation command (ACT). The row address decoder 506 selects the word line for the row addressed in the read transaction, and the ACT causes the row address decoder 506 to move all of the data contents of the selected row from the DRAM array into a row buffer 510, an operation that is often referred to as 608 “opening the row.” The column address (i.e., column ID) of the read transaction is sent to a column decoder 512, along with a column access command (CAS). With the addressed row data now open in the row buffer 510, the CAS causes the column address decoder 512 to 610 read out data from the open row buffer 510 at the column positions associated with the column address. In some examples, the column address includes an offset, and the column decoder 512 reads out data starting at the column address and ending at the offset from the column address. The data that has been read out into the column decoder 512 is 612 sent via a data bus 514 to the memory controller, which responds to the data request.

In traditional read transaction processing, the read transaction would be removed from the RPQ entry once the column decoder had retrieved the data, and the memory controller would either close the row or leave the row open, depending on the page policy of the memory system. For the currently disclosed technology, however, an appended read transaction can include at least one subsequent column ID in the RPQ entry. In some examples, the column ID for the first transaction can be disabled or removed, leaving the original rank, bank, and row IDs and the subsequent column ID in the entry. In such cases, the memory controller will process the subsequent column ID as another read transaction. In essence, the subsequent column ID is hidden from the controller behind the first column ID until the first read transaction has been processed, and then is treated as a new transaction. Because the rank, bank, and row are open from the prior read transaction, the subsequent read transaction will result in, and be processed as, a row hit (i.e., page hit).

More specifically, if a subsequent column ID remains in the RPQ entry, 614 a set of DRAM commands is generated for at least the rank, bank, row, and subsequent column ID. The memory controller receives a page hit due to the addressed row being open, and the subsequent column ID and a CAS is sent to the column decoder 512, which causes the column address decoder 512 to 610 read out data from the open row buffer 510 at the column positions associated with the column ID, in this case, the subsequent column ID. The data for the subsequent read transaction that has been read out into the column decoder 512 is 612 sent via a data bus 514 to the memory controller, which responds to the associated data request. In some cases, however, the memory controller may have closed the row prior to processing the subsequent read transaction, and in such cases, the memory controller will generate the set of DRAM commands and process the subsequent read transaction as a page miss, where the rank, bank, and row are reopened. Once the RPQ entry is empty, the memory controller can 618 close the row by sending a precharge command (PRE) to the row address decoder 508 via the command and address bus 502.

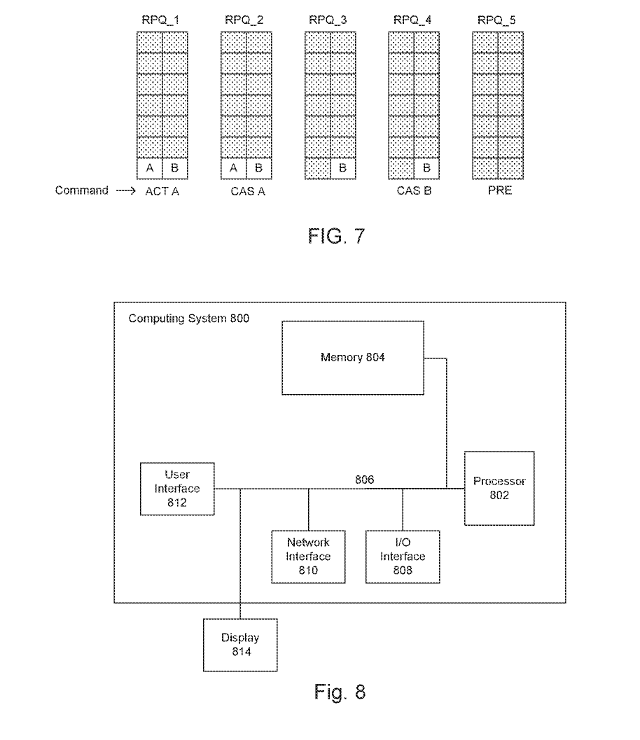

FIG. 7 shows one example of how a memory controller manages an appended read transaction in the RPQ. In this case, a read transaction similar to FIG. 2 is shown in the bottom entry of the RPQ, with at least the rank, bank, row, and column ID of read transaction A in the left field, and the column ID of read transaction B in the right field. As has been described above, the memory controller generates the DRAM commands for A (ACT A and CAS A), and at RPQ_1 (RPQ at time 1) the ACT A is sent to the row address decoder 508 of the open bank 500 via the command and address bus 502 (see FIG. 5). This causes the addressed row to be opened, and all of the data in that row to be moved into the row buffer 510. At RPQ_2, the CAS A is sent along the command and address bus 502 to the column decoder 512, which causes the data that is associated with the column ID to be read out of the row buffer 410 to fill the read request A. Read transaction A is then removed from, or disabled in, the RPQ, as shown at RPQ_3. Regardless of the page policy of the DRAM system, the row is left open in the row buffer 510 because there is still an entry in the RPQ that is associated with the open rank and bank. Read transaction B and the associated column ID is still in the RPQ entry, and is associated with at least the rank, bank, and row IDs of the read transaction A. The memory controller generates at least the CAS DRAM command for read transaction B (CAS B), which is sent to the column decoder 512, shown at RPQ_4. CAS B causes the data that is associated with the column ID of read transaction B to be read out of the open row buffer 510 to fill the read request B, and the read transaction B is removed from the RPQ, as shown at RPQ_5. Once the entry is empty, the memory controller can follow the page policy of the DRAM system, and either, for example, close the row by sending the PRE to the row address decoder 508, or leave the row open.

FIG. 8 illustrates an example of a general computing system or device 800 that can be employed in the present technology, in some examples as a host system. While any type or configuration of device or computing system is contemplated to be within the present scope, non-limiting examples can include node computing systems, system-on-a-chip (SoC) systems, server systems, networking systems, high capacity computing systems, laptop computers, tablet computers, desktop computers, smart phones, or the like.

The computing system 800 can include one or more processors 802 in communication with a memory 804. The memory 804 can include any device, combination of devices, circuitry, or the like, that is capable of storing, accessing, organizing, and/or retrieving data. Additionally, a communication interface 806, such as a local communication interface, for example, provides connectivity between the various components of the system. For example, the communication interface 806 can be a local data bus and/or any related address or control busses as may be useful.

The computing system 800 can also include an I/O (input/output) interface 808 for controlling the I/O functions of the system, as well as for I/O connectivity to devices outside of the computing system 800. A network interface 810 can also be included for network connectivity. The network interface 810 can control network communications both within the system and outside of the system, and can include a wired interface, a wireless interface, a Bluetooth interface, optical interface, communication fabric, and the like, including appropriate combinations thereof. Furthermore, the computing system 800 can additionally include a user interface 812, a display device 814, as well as various other components that would be beneficial for such a system.

The processor 802 can be a single or multiple processors, including single or multiple processor cores, and the memory can be a single or multiple memories. The local communication interface can be used as a pathway to facilitate communication between any of a single processor or processor cores, multiple processors or processor cores, a single memory, multiple memories, the various interfaces, and the like, in any useful combination.

The memory 804 can include a memory with volatile memory, nonvolatile memory (NVM), or a combination thereof. Volatile memory is a storage medium that requires power to maintain the state of data stored by the medium. Exemplary memory can include any combination of random access memory (RAM), such as static random access memory (SRAM), dynamic random access memory (DRAM), synchronous dynamic random access memory (SDRAM), and the like. In some examples, DRAM complies with a standard promulgated by JEDEC, such as JESD79F for Double Data Rate (DDR) SDRAM, JESD79-2F for DDR2 SDRAM, JESD79-3F for DDR3 SDRAM, or JESD79-4A for DDR4 SDRAM (these standards are available at www.jedec.org).

NVM is a storage medium that does not require power to maintain the state of data stored by the medium. Nonlimiting examples of NVM can include any or a combination of solid state memory (such as planar or three-dimensional (3D) NAND flash memory, NOR flash memory, or the like), cross point array memory, including 3D cross point memory, phase change memory (PCM), such as chalcogenide PCM, non-volatile dual in-line memory module (NVDIMM), a network attached storage, byte addressable nonvolatile memory, ferroelectric memory, silicon-oxide-nitride-oxide-silicon (SONOS) memory, polymer memory (e.g., ferroelectric polymer memory), ferroelectric transistor random access memory (Fe-TRAM) ovonic memory, spin transfer torque (STT) memory, nanowire memory, electrically erasable programmable read-only memory (EEPROM), magnetic storage memory, write in place non-volatile MRAM (NVMRAM), and the like. In some examples, non-volatile memory can comply with one or more standards promulgated by the Joint Electron Device Engineering Council (JEDEC), such as JESD218, JESD219, JESD220-1, JESD223B, JESD223-1, or other suitable standard (the JEDEC standards cited herein are available at www.jedec.org).

Various techniques, or certain aspects or portions thereof, can take the form of program code (i.e., instructions) embodied in tangible media, such as floppy diskettes, CD-ROMs, hard drives, non-transitory computer readable storage medium, or any other machine-readable storage medium wherein, when the program code is loaded into and executed by a machine, such as a computer, the machine becomes an apparatus for practicing the various techniques. Circuitry can include hardware, firmware, program code, executable code, computer instructions, and/or software. A non-transitory computer readable storage medium can be a computer readable storage medium that does not include signal. In the case of program code execution on programmable computers, the computing device can include a processor, a storage medium readable by the processor (including volatile and non-volatile memory and/or storage elements), at least one input device, and at least one output device. The volatile and non-volatile memory and/or storage elements can be a RAM, EPROM, flash drive, optical drive, magnetic hard drive, solid state drive, or other medium for storing electronic data.

Various techniques, or certain aspects or portions thereof, can take the form of program code (i.e., instructions) embodied in tangible media, such as floppy diskettes, CD-ROMs, hard drives, non-transitory computer readable storage medium, or any other machine-readable storage medium wherein, when the program code is loaded into and executed by a machine, such as a computer, the machine becomes an apparatus for practicing the various techniques. Circuitry can include hardware, firmware, program code, executable code, computer instructions, and/or software. A non-transitory computer readable storage medium can be a computer readable storage medium that does not include signal. In the case of program code execution on programmable computers, the computing device can include a processor, a storage medium readable by the processor (including volatile and non-volatile memory and/or storage elements), at least one input device, and at least one output device. The volatile and non-volatile memory and/or storage elements can be a RAM, EPROM, flash drive, optical drive, magnetic hard drive, solid state drive, or other medium for storing electronic data.

### EXAMPLES

The following examples pertain to specific embodiments and point out specific features, elements, or steps that can be used or otherwise combined in achieving such embodiments.

In one example, there is provided an electronic device, comprising a memory interface and a memory controller configured to communicatively couple to a memory through the memory interface. The memory controller comprises a RPQ and circuitry configured to receive, from a host, an incoming read request including a physical address ID comprising a row and column ID, perform a lookup of the RPQ for an entry having a pending read transaction with a physical address ID having the same row ID as the incoming read request. If the RPQ lookup returns a hit, the circuitry appends the incoming read request's column ID to the physical address ID of the pending read transaction to form an appended read transaction, and if the RPQ lookup returns a miss, the circuitry adds a new RPQ entry in the RPQ for the incoming read request.

In one example of a device, the physical address ID of the incoming read request comprises a rank, bank, row, and column ID, and the circuitry is further configured to perform the lookup of the RPQ for an entry having a pending read transaction with a physical address ID having the same rank, bank, and row ID as the incoming read request.

In one example of a device, the circuitry, to process the appended read transaction, is further configured to generate a first set of memory commands for the pending read transaction from the rank, bank, row, and column ID of the pending read transaction, process the first set of memory commands, generate a second set of memory commands for processing the incoming read request from the rank, bank, and row ID of the pending read transaction and the column ID of the incoming read request, and process the second set of memory commands.

In one example of a device, the circuitry, in processing the first set of memory commands, is further configured to send the first set of memory commands to the memory through the memory interface.

In one example of a device, the circuitry, in processing the second set of memory commands, is further configured to send the second set of memory commands to the memory through the memory interface.

In one example of a device, the circuitry is further configured to open a rank, bank, and a row in the memory corresponding to the physical address ID of the pending read transaction, read out data from the open row corresponding to the pending read transaction column ID, send the data from the pending read transaction column ID to the memory controller, read out data from the open row corresponding to the incoming read request column ID, send the data from the incoming read transaction column ID to the memory controller, and close the open row.

In one example of a device, the circuitry is further configured to receive, from the host, a higher priority read request compared to the incoming read request prior to reading out the data associated with the incoming read request column ID, enter the incoming read request into the RPQ with the rank, bank, and row ID of the pending read transaction, and the column ID of the incoming read data request, and process the higher priority read request.

In one example of a device, the circuitry, in processing the higher priority read request, is further configured to compare a rank, bank, and row ID of the higher priority read request to the row ID of the open row, if the row ID of the high priority read request corresponds to the open row, read out data associated with a column ID of the high priority read request from the open row, and if the row ID of the high priority read request does not correspond to the open row, close the open row.

In one example of a device, the incoming read request further comprises a channel ID, and the circuitry is configured to perform the lookup of the RPQ for an entry having a pending read transaction with a physical address ID including the same channel, rank, bank, and row ID as the incoming read request.

In one example of a device, the incoming read request further comprises a DIMM ID, and the circuitry is configured to perform the lookup of the RPQ for an entry having a pending read transaction with a physical address ID including the same DIMM, rank, bank, and row ID as the incoming read request.

In one example of a device, the incoming read request further comprises a channel ID and a DIMM ID, and the circuitry is configured to perform the lookup of the RPQ for an entry having a pending read transaction with a physical address ID including the same channel, DIMM. rank, bank, and row ID as the incoming read request.

In one example of a device, the circuitry is further configured to receive, from the host, a subsequent read request including a physical address ID comprising a rank, bank, row, and column ID, perform a lookup of the RPQ for an entry having a subsequent pending read transaction with a physical address ID having the same rank, bank, and row ID as the subsequent read request, if the RPQ lookup returns a hit, append the subsequent read request's column ID to the physical address ID of the subsequent pending read transaction to form a subsequent appended read transaction, and if the RPQ lookup returns a miss, add a new RPQ entry in the RPQ for the subsequent read request.

In one example of a device, the subsequent pending read transaction is the appended read transaction, and in forming the subsequent appended read transaction, the circuitry is further configured to append the subsequent read request column ID to the physical address ID of the appended read transaction.

In one example of a device, the circuitry, in appending the subsequent read request column ID to the physical address ID field of the appended read transaction, is further configured to append the subsequent read request column ID following the incoming read request column ID in the physical address ID field of the appended read transaction.

In one example of a device, the circuitry, in appending the incoming read request column ID to the physical address ID field of the pending read transaction, is further configured to verify that the physical address ID field of the pending read transaction has sufficient space in the RPQ entry to append the incoming read request column ID, and allocate additional space to the RPQ entry if the physical address ID field of the pending read transaction has insufficient space.

In one example of a device, further comprising a memory coupled to the memory controller through the memory interface.

In one example, there is provided a computing system comprising a host, a host interface coupled to the host, a memory, a memory interface coupled to the memory, a memory controller communicatively coupled to the memory through the memory interface and to the host through the host interface, comprising a RPQ and circuitry configured to receive, from the host through the host interface, an incoming read request including a physical address identification (ID) comprising a row and column ID, perform a lookup of the RPQ for an entry having a pending read transaction with a physical address ID having the same row ID as the incoming read request, if the RPQ lookup returns a hit, append the incoming read request's column ID to the physical address ID of the pending read transaction to form an appended read transaction, and if the RPQ lookup returns a miss, add a new RPQ entry in the RPQ for the incoming read request.

In one example of a system, the physical address ID of the incoming read request comprises a rank, bank, row, and column ID, and the circuitry is further configured to perform the lookup of the RPQ for an entry having a pending read transaction with a physical address ID having the same rank, bank, and row ID as the incoming read request.

In one example of a system, the circuitry, to process the appended read transaction, is further configured to generate a first set of memory commands for the pending read transaction from the rank, bank, row, and column ID of the pending read transaction, process the first set of memory commands, generate a second set of memory commands for processing the incoming read request from the rank, bank, and row ID of the pending read transaction and the column ID of the incoming read request, and process the second set of memory commands.

In one example of a system, the circuitry, in processing the first set of memory commands, is further configured to send the first set of memory commands to the memory through the memory interface.

In one example of a system, the circuitry, in processing the second set of memory commands, is further configured to send the second set of memory commands to the memory through the memory interface.

In one example of a system, the circuitry is further configured to open a rank, bank, and a row in the memory corresponding to the physical address ID of the pending read transaction, read out data from the open row corresponding to the pending read transaction column ID, send the data from the pending read transaction column ID to the memory controller, read out data from the open row corresponding to the incoming read request column ID, send the data from the incoming read transaction column ID to the memory controller, and close the open row.

In one example of a system, the circuitry is further configured to receive, from the host through the host interface, a higher priority read request compared to the incoming read request prior to reading out the data associated with the incoming read request column ID, enter the incoming read request into the RPQ with the rank, bank, and row ID of the pending read transaction and the column ID of the incoming read data request, and process the higher priority read request.

In one example of a system, wherein the circuitry, in processing the higher priority read request, is further configured to compare a rank, bank, and row ID of the higher priority read request to the row ID of the open row, if the row ID of the high priority read request corresponds to the open row, read out data associated with a column ID of the high priority read request from the open row, and if the row ID of the high priority read request does not correspond to the open row, close the open row.

In one example of a system, wherein the incoming read request further comprises a channel ID, and the circuitry is configured to perform the lookup of the RPQ for an entry having a pending read transaction with a physical address ID including the same channel, rank, bank, and row ID as the incoming read request.

In one example of a system, wherein the incoming read request further comprises a DIMM ID, and the circuitry is configured to perform the lookup of the RPQ for an entry having a pending read transaction with a physical address ID including the same DIMM, rank, bank, and row ID as the incoming read request.

In one example of a system, wherein the incoming read request further comprises a channel ID and a DIMM ID, and the circuitry is configured to perform the lookup of the RPQ for an entry having a pending read transaction with a physical address ID including the same channel, DIMM. rank, bank, and row ID as the incoming read request.

In one example of a system, the circuitry is further configured to receive, from the host through the host interface, a subsequent read request including a physical address ID comprising a rank, bank, row, and column ID, perform a lookup of the RPQ for an entry having a subsequent pending read transaction with a physical address ID having the same rank, bank, and row ID as the subsequent read request. If the RPQ lookup returns a hit, the circuitry appends the subsequent read request's column ID to the physical address ID of the subsequent pending read transaction to form a subsequent appended read transaction, and if the RPQ lookup returns a miss, the circuitry adds a new RPQ entry in the RPQ for the subsequent read request.

In one example of a system, wherein the subsequent pending read transaction is the appended read transaction, and in forming the subsequent appended read transaction, the circuitry is further configured to append the subsequent read request column ID to the physical address ID of the appended read transaction.

In one example of a system, the circuitry, in appending the subsequent read request column ID to the physical address ID field of the appended read transaction, is further configured to append the subsequent read request column ID following the incoming read request column ID in the physical address ID field of the appended read transaction.

In one example of a system, the circuitry, in appending the incoming read request column ID to the physical address ID field of the pending read transaction, is further configured to verify that the physical address ID field of the pending read transaction has sufficient space in the RPQ entry to append the incoming read request column ID, and allocate additional space to the RPQ entry if the physical address ID field of the pending read transaction has insufficient space.

In one example, there is provided a computer-implemented method for increasing RPQ size in a memory controller, comprising receiving, at a memory controller, an incoming read request from a host through a host interface, the incoming read request including a physical address ID comprising a row and column ID, performing, at the memory controller, a lookup of an RPQ for an entry having a pending read transaction with a physical address ID having the same row ID as the incoming read request, if the RPQ lookup returns a hit, appending the incoming read request's column ID to the physical address ID of the pending read transaction to form an appended read transaction, and if the RPQ lookup returns a miss, adding a new RPQ entry in the RPQ for the incoming read request.

In one example of a method, the physical address ID of the incoming read request comprises a rank, bank, row, and column ID, and the method further comprises performing the lookup of the RPQ for an entry having a pending read transaction with a physical address ID having the same rank, bank, and row ID as the incoming read request.

In one example of a method, the method further comprises processing the appended read transaction, including generating, in the memory controller, a first set of memory commands for the pending read transaction from the rank, bank, row, and column ID of the pending read transaction, processing the first set of memory commands, generating, in the memory controller, a second set of memory commands for processing the incoming read request from the rank, bank, and row ID of the pending read transaction and the column ID of the incoming read request, and processing the second set of memory commands.

In one example of a method, the method, in processing the first set of memory commands, further comprises sending, the first set of memory commands from the memory controller to a memory through a memory interface.

In one example of a method, the method, in processing the second set of memory commands, further comprises sending the second set of memory commands from the memory controller to the memory through the memory interface.

In one example of a method, the method further comprises opening a rank, bank, and a row in a memory corresponding to the physical address ID of the pending read transaction, reading out data from the open row corresponding to the pending read transaction column ID, sending the data from the pending read transaction column ID to the memory controller, reading out data from the open row corresponding to the incoming read request column ID, sending the data from the incoming read transaction column ID to the memory controller, and closing the open row.

In one example of a method, the method further comprises receiving, from the host through the host interface, a higher priority read request compared to the incoming read request prior to reading out the data associated with the incoming read request column ID, entering the incoming read request into the RPQ with the rank, bank, and row ID of the pending read transaction, and the column ID of the incoming read data request, and processing the higher priority read request.

In one example of a method, the method, in processing the higher priority read request, further comprises comparing, in the memory controller, a rank, bank, and row ID of the higher priority read request to the row ID of the open row, if the row ID of the high priority read request corresponds to the open row, read out data associated with a column ID of the high priority read request from the open row, and if the row ID of the high priority read request does not correspond to the open row, close the open row.

In one example of a method, the incoming read request further comprises a channel ID, and the method further comprises performing the lookup of the RPQ for an entry having a pending read transaction with a physical address ID including the same channel, rank, bank, and row ID as the incoming read request.

In one example of a method, the incoming read request further comprises a DIMM ID, and the method further comprises performing the lookup of the RPQ for an entry having a pending read transaction with a physical address ID including the same DIMM, rank, bank, and row ID as the incoming read request.

In one example of a method, the incoming read request further comprises a channel ID and a DIMM ID, and the method further comprises performing the lookup of the RPQ for an entry having a pending read transaction with a physical address ID including the same channel, DIMM. rank, bank, and row ID as the incoming read request.

In one example of a method, the method further comprises receiving, from the host through the host interface, a subsequent read request including a physical address ID comprising a rank, bank, row, and column ID, performing, in the memory controller, a lookup of the RPQ for an entry having a subsequent pending read transaction with a physical address ID having the same rank, bank, and row ID as the subsequent read request, if the RPQ lookup returns a hit, appending the subsequent read request's column ID to the physical address ID of the subsequent pending read transaction to form a subsequent appended read transaction, and if the RPQ lookup returns a miss, adding a new RPQ entry in the RPQ for the subsequent read request.

In one example of a method, the subsequent pending read transaction is the appended read transaction, and in forming the subsequent appended read transaction, the method further comprises appending the subsequent read request column ID to the physical address ID of the appended read transaction.

In one example of a method, the method, in appending the subsequent read request column ID to the physical address ID field of the appended read transaction, further comprises appending the subsequent read request column ID following the incoming read request column ID in the physical address ID field of the appended read transaction.

In one example of a method, the method, in appending the incoming read request column ID to the physical address ID field of the pending read transaction, further comprises verifying, by the memory controller, that the physical address ID field of the pending read transaction has sufficient space in the RPQ entry to append the incoming read request column ID, and allocating, by the memory controller, additional space to the RPQ entry if the physical address ID field of the pending read transaction has insufficient space.

1. An electronic device, comprising;
a memory interface;
a memory controller configured to communicatively couple to a memory through the memory interface, comprising:
a read pending queue (RPQ); and
circuitry configured to:
receive, from a host, an incoming read request including a physical address identification (ID) comprising a row and column ID;
perform a lookup of the RPQ for an entry having a pending read transaction with a physical address ID having the same row ID as the incoming read request;
if the RPQ lookup returns a hit, append the incoming read request's column ID to the physical address ID of the pending read transaction to form an appended read transaction; and
if the RPQ lookup returns a miss, add a new RPQ entry in the RPQ for the incoming read request.

2. The device of claim 1, wherein the physical address ID of the incoming read request comprises a rank, bank, row, and column ID; and
the circuitry is further configured to perform the lookup of the RPQ for an entry having a pending read transaction with a physical address ID having the same rank, bank, and row ID as the incoming read request.

3. The device of claim 2, wherein the circuitry, to process the appended read transaction, is further configured to:
generate a first set of memory commands for the pending read transaction from the rank, bank, row, and column ID of the pending read transaction;
process the first set of memory commands;
generate a second set of memory commands for processing the incoming read request from the rank, bank, and row ID of the pending read transaction and the column ID of the incoming read request; and
process the second set of memory commands.

4. The device of claim 3, wherein the circuitry is further configured to:
open a rank, bank, and a row in the memory corresponding to the physical address ID of the pending read transaction;
read out data from the open row corresponding to the pending read transaction column ID;
send the data from the pending read transaction column ID to the memory controller;
read out data from the open row corresponding to the incoming read request column ID;
send the data from the incoming read transaction column ID to the memory controller; and
close the open row.

5. The device of claim 4, wherein the circuitry is further configured to:
receive, from the host, a higher priority read request compared to the incoming read request prior to reading out the data associated with the incoming read request column ID;
enter the incoming read request into the RPQ with the rank, bank, and row ID of the pending read transaction, and the column ID of the incoming read data request; and
process the higher priority read request.

6. The device of claim 5, wherein, in processing the higher priority read request, the circuitry is further configured to:
compare a rank, bank, and row ID of the higher priority read request to the row ID of the open row;
if the row ID of the high priority read request corresponds to the open row, read out data associated with a column ID of the high priority read request from the open row; and
if the row ID of the high priority read request does not correspond to the open row, close the open row.

7. The device of claim 2, wherein the incoming read request further comprises a channel ID, and the circuitry is configured to perform the lookup of the RPQ for an entry having a pending read transaction with a physical address ID including the same channel, rank, bank, and row ID as the incoming read request.

8. The device of claim 2, wherein the incoming read request further comprises a DIMM ID, and the circuitry is configured to perform the lookup of the RPQ for an entry having a pending read transaction with a physical address ID including the same DIMM, rank, bank, and row ID as the incoming read request.

9. The device of claim 2, wherein the incoming read request further comprises a channel ID and a DIMM ID, and the circuitry is configured to perform the lookup of the RPQ for an entry having a pending read transaction with a physical address ID including the same channel, DIMM. rank, bank, and row ID as the incoming read request.

10. The device of claim 2, wherein the circuitry is further configured to:
receive, from the host, a subsequent read request including a physical address ID comprising a rank, bank, row, and column ID;
perform a lookup of the RPQ for an entry having a subsequent pending read transaction with a physical address ID having the same rank, bank, and row ID as the subsequent read request;
if the RPQ lookup returns a hit, append the subsequent read request's column ID to the physical address ID of the subsequent pending read transaction to form a subsequent appended read transaction; and
if the RPQ lookup returns a miss, add a new RPQ entry in the RPQ for the subsequent read request.

11. The device of claim 10, wherein the subsequent pending read transaction is the appended read transaction, and in forming the subsequent appended read transaction, the circuitry is further configured to:
append the subsequent read request column ID to the physical address ID of the appended read transaction.

12. The device of claim 2, wherein the circuitry, in appending the incoming read request column ID to the physical address ID field of the pending read transaction, is further configured to:
verify that the physical address ID field of the pending read transaction has sufficient space in the RPQ entry to append the incoming read request column ID; and
allocate additional space to the RPQ entry if the physical address ID field of the pending read transaction has insufficient space.

13. A computing system, comprising;
a host;
a host interface coupled to the host;
a memory;
a memory interface coupled to the memory;
a memory controller communicatively coupled to the memory through the memory interface and to the host through the host interface, comprising:
a read pending queue (RPQ); and
circuitry configured to:
receive, from the host through the host interface, an incoming read request including a physical address identification (ID) comprising a row and column ID;
perform a lookup of the RPQ for an entry having a pending read transaction with a physical address ID having the same row ID as the incoming read request;
if the RPQ lookup returns a hit, append the incoming read request's column ID to the physical address ID of the pending read transaction to form an appended read transaction; and
if the RPQ lookup returns a miss, add a new RPQ entry in the RPQ for the incoming read request.

14. The system of claim 13, wherein the physical address ID of the incoming read request comprises a rank, bank, row, and column ID; and
the circuitry is further configured to perform the lookup of the RPQ for an entry having a pending read transaction with a physical address ID having the same rank, bank, and row ID as the incoming read request.

15. The system of claim 13, wherein the circuitry, to process the appended read transaction, is further configured to:
generate a first set of memory commands for the pending read transaction from the rank, bank, row, and column ID of the pending read transaction;
process the first set of memory commands;
generate a second set of memory commands for processing the incoming read request from the rank, bank, and row ID of the pending read transaction and the column ID of the incoming read request; and
process the second set of memory commands.

16. The system of claim 15, wherein the circuitry is further configured to:
open a rank, bank, and a row in the memory corresponding to the physical address ID of the pending read transaction;
read out data from the open row corresponding to the pending read transaction column ID;
send the data from the pending read transaction column ID to the memory controller;
read out data from the open row corresponding to the incoming read request column ID;
send the data from the incoming read transaction column ID to the memory controller; and
close the open row.

17. The system of claim 13, wherein the circuitry, in appending the incoming read request column ID to the physical address ID field of the pending read transaction, is further configured to:
verify that the physical address ID field of the pending read transaction has sufficient space in the RPQ entry to append the incoming read request column ID; and
allocate additional space to the RPQ entry if the physical address ID field of the pending read transaction has insufficient space.

18. A computer-implemented method for increasing read pending que (RPQ) size in a memory controller, comprising:
receiving, at a memory controller, an incoming read request from a host through a host interface, the incoming read request including a physical address identification (ID) comprising a row and column ID;
performing, at the memory controller, a lookup of an RPQ for an entry having a pending read transaction with a physical address ID having the same row ID as the incoming read request;
if the RPQ lookup returns a hit, appending the incoming read request's column ID to the physical address ID of the pending read transaction to form an appended read transaction; and
if the RPQ lookup returns a miss, adding a new RPQ entry in the RPQ for the incoming read request.

19. The method of claim 18, wherein the physical address ID of the incoming read request comprises a rank, bank, row, and column ID; and
the method further comprises performing the lookup of the RPQ for an entry having a pending read transaction with a physical address ID having the same rank, bank, and row ID as the incoming read request.

20. The method of claim 18, wherein the method further comprises:
processing the appended read transaction, including:
generating, in the memory controller, a first set of memory commands for the pending read transaction from the rank, bank, row, and column ID of the pending read transaction;
processing the first set of memory commands;
generating, in the memory controller, a second set of memory commands for processing the incoming read request from the rank, bank, and row ID of the pending read transaction and the column ID of the incoming read request; and
processing the second set of memory commands.

21. The method of claim 20, further comprising:
opening a rank, bank, and a row in a memory corresponding to the physical address ID of the pending read transaction;
reading out data from the open row corresponding to the pending read transaction column ID;
sending the data from the pending read transaction column ID to the memory controller;
reading out data from the open row corresponding to the incoming read request column ID;
sending the data from the incoming read transaction column ID to the memory controller; and
closing the open row.

22. The method of claim 18, wherein the incoming read request further comprises a channel ID, and the method further comprises performing the lookup of the RPQ for an entry having a pending read transaction with a physical address ID including the same channel, rank, bank, and row ID as the incoming read request.

23. The method of claim 18, wherein the incoming read request further comprises a DIMM ID, and the method further comprises performing the lookup of the RPQ for an entry having a pending read transaction with a physical address ID including the same DIMM, rank, bank, and row ID as the incoming read request.

24. The method of claim 18, wherein the incoming read request further comprises a channel ID and a DIMM ID, and the method further comprises performing the lookup of the RPQ for an entry having a pending read transaction with a physical address ID including the same channel, DIMM. rank, bank, and row ID as the incoming read request.

25. The method of claim 18, further comprising:
receiving, from the host through the host interface, a subsequent read request including a physical address ID comprising a rank, bank, row, and column ID;
performing, in the memory controller, a lookup of the RPQ for an entry having a subsequent pending read transaction with a physical address ID having the same rank, bank, and row ID as the subsequent read request;
if the RPQ lookup returns a hit, appending the subsequent read request's column ID to the physical address ID of the subsequent pending read transaction to form a subsequent appended read transaction; and
if the RPQ lookup returns a miss, adding a new RPQ entry in the RPQ for the subsequent read request.

26. The method of claim 25, wherein the subsequent pending read transaction is the appended read transaction, and in forming the subsequent appended read transaction, the method further comprises:
appending the subsequent read request column ID to the physical address ID of the appended read transaction.

27. The method of claim 18, wherein the method, in appending the incoming read request column ID to the physical address ID field of the pending read transaction, further comprises:
verifying, by the memory controller, that the physical address ID field of the pending read transaction has sufficient space in the RPQ entry to append the incoming read request column ID; and
allocating, by the memory controller, additional space to the RPQ entry if the physical address ID field of the pending read transaction has insufficient space.
